(19) United States
(12) Patent Application Publication
(10) Pub. No.: US 2010/0293567 A1
(43) Pub. Date: Nov. 18, 2010

(54) METHOD AND SYSTEM FOR REMOTE CONTROL INTERACTIONS ANALYTICS

(75) Inventors: Jean-Etienne GAUDREAU, Longueuil (CA); Marc TREMBLAY, Montreal (CA); Eric MÉLIN, Montreal (CA)

Correspondence Address: BCF LLP, 1100 RENE'-LE'VESQUE BLVD. WEST, 25TH FLOOR, MONTREAL, QC, H3B-5C9, CA

(73) Assignee: NEURALITIC SYSTEMS, Montreal (CA)

(21) Appl. No.: 12/779,360

(22) Filed: May 13, 2010

Related U.S. Application Data
(63) Continuation of application No. 61/178,656, filed on May 15, 2009.

(51) Int. Cl. H04H 60/32

(52) U.S. Cl. 725/14

(57) ABSTRACT

The present relates to a method and a system for analyzing interactions between a remote control and associated multimedia appliances. The method and system intercept transmissions representative of the interactions between the remote control and the associated multimedia appliances, and extract there from data related to the interactions. Then, the method and system process and interpret the data related to the interactions, and allocate a timestamp to some of the interactions. The method and system also generate a subscriber's profile based on the interpretation of the data related to the interactions, store the subscriber's profile, and transmit the subscriber's profile to a centralized analytic server.

### FIELD

The present is related to interception, recording, and analysis of the interactions between a remote control and multimedia appliances such as a television, a set top box, or a digital video disk; and more particularly to a method and system for remote control interactions analytics.

### BRIEF DESCRIPTION OF THE DRAWINGS

In the appended drawings:

FIG. 1 illustrates a system for remote control interactions analytics, according to a non-restrictive illustrative embodiment;

FIG. 2 illustrates a method for remote control interactions analytics, according to a non-restrictive illustrative embodiment; and

FIG. 3 illustrates a metering system of a method and system for remote control interactions analytics, according to a non-restrictive illustrative embodiment.

### DETAILED DESCRIPTION

Nowadays, the typical household is equipped with multiple multimedia appliances that can be operated via a remote control device. Generally, the core of the household multimedia environment is a television and a set top box to receive cable television, satellite television and/or IPTV (Internet Protocol television). Additional appliances such as a DVD (Digital Video Disk), a PVR (Personal Video Recorder), home theatre equipment or stereo equipment, are also common. A single universal remote control or a combination of several dedicated remote controls is used by the multimedia consumer to interact with these different multimedia appliances.

Various stakeholders are interested in gathering and analyzing habits and behaviours of subscribers in terms of multimedia consumption. The most current example is the use of a metering device, located at the subscriber's premises, to monitor which television channels are being viewed and for how long. Such a metering device takes into account a single multimedia appliance: the television itself. Thus, it does not provide an exhaustive overview of the presence and usage of various multimedia appliances located in a specific household.

Therefore, there is a need of overcoming the above discussed limitation, by taking into account all the multimedia appliances of the household which rely on a remote control for user's interactions. An object of the present invention is therefore to provide a method and system for remote control interactions analytics.

In a general embodiment, the present method is adapted for analyzing interactions between a remote control and associated multimedia appliances. For doing so, the method intercepts transmissions representative of the interactions between the remote control and the associated multimedia appliances. The method extracts data related to the interactions from the transmissions. Then, the method processes and interprets the data related to the interactions, the processing comprising allocation of a timestamp to some of the interactions. The method further generates a subscriber's profile based on the interpretation of the data related to the interactions, stores the subscriber's profile, and transmits the subscriber's profile to a centralized analytic server.

In another general embodiment, the present system is adapted for analyzing interactions between a remote control and associated multimedia appliances. For doing so, the system comprises a receiver for intercepting transmissions representative of the interactions between the remote control and the associated multimedia appliances. The system comprises a demodulator for extracting data related to the interactions from the transmissions. The system also comprises a processing unit for processing and interpreting the data related to the interactions, and for allocating a timestamp to some of the interactions. The processing unit further generates a subscriber's profile based on the interpretation of the data related to the interactions. Then, the system comprises a storage entity for storing the subscriber's profile, and a communication module for transmitting the subscriber's profile to a centralized analytic server.

The present method and system apply to any type of multimedia appliance located at a subscriber's household, and which can be operated via a remote control. Such types of multimedia appliances include (but are not limited to): televisions, Set Top Boxes (STB) (for cable television, satellite television, IPTV), DVDs, PVRs, home theatre equipments, stereo equipments, etc.

The interception, processing, and interpretation of the aforementioned interactions are performed by a dedicated metering system located at the subscriber's premises. The resulting information includes (but is not limited to): a list of multimedia appliances detected by the metering system, a list of users' interactions with each detected multimedia appliance, and timestamps indicating the time of occurrence of the interactions. This information is further processed by the metering system to generate/update a subscriber's profile.

A centralized analytic server analyzes, from a marketing perspective, the subscriber's profiles transmitted by the metering systems located in a plurality of subscriber's households. The list of multimedia appliances present at a subscriber's household, as well as the user's habits and behaviors related to these appliances, can be used to detect opportunities for suggesting the acquisition of new equipments or services to targeted subscribers. It can also be used to elaborate generic trends related to the multimedia appliances and services markets.

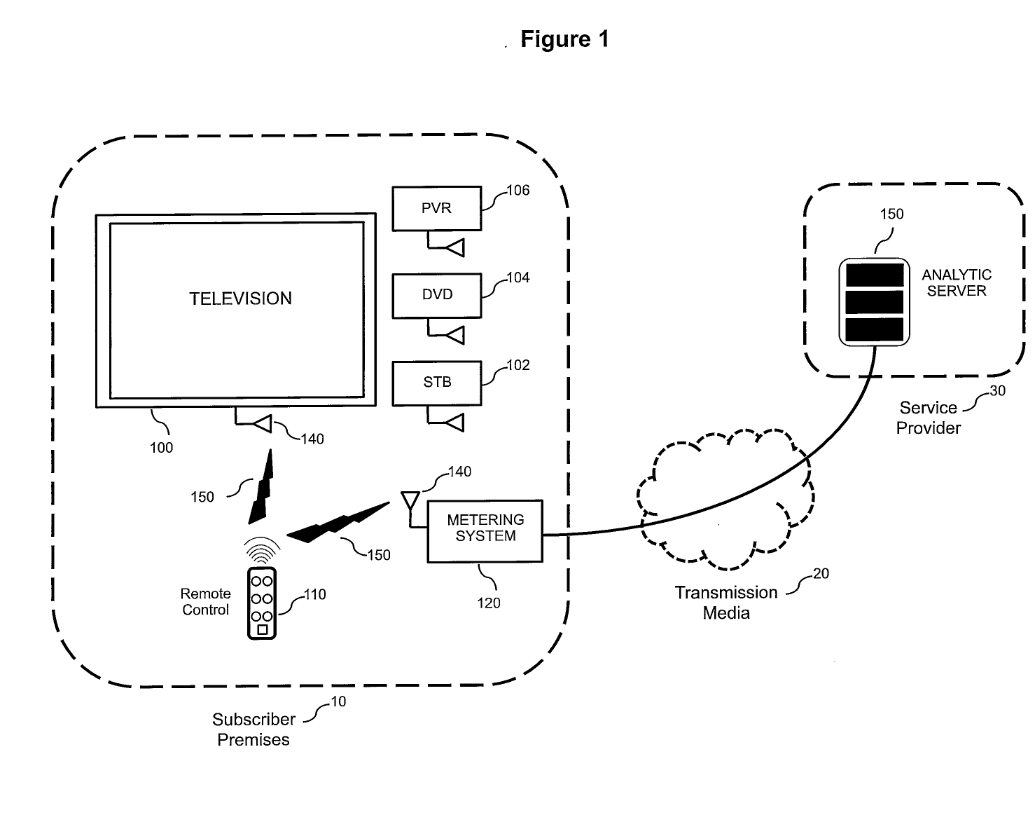

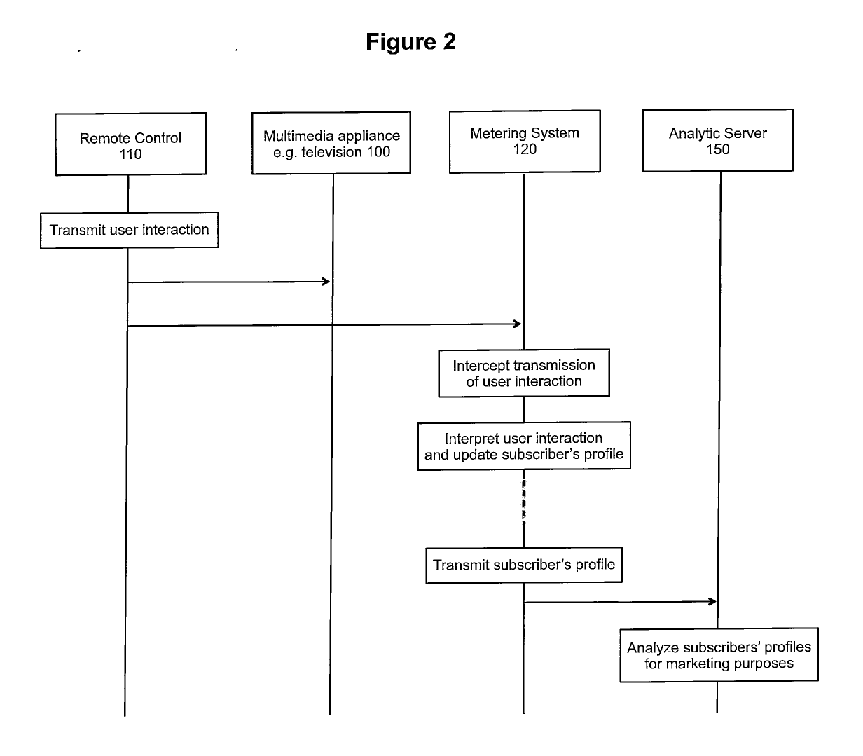

Referring now concurrently to FIGS. 1 and 2, a method and system for remote control interactions analytics will be described.

A metering system 120 is considered in FIG. 1. It is located at a subscriber's premises 10. The notion of subscriber refers to the status of a household as being a customer of a television service, which can be provided via a variety of technologies, including cable television, satellite television or IPTV.

The notion of subscriber's premises 10 is defined as the location in the subscriber's household where most of the multimedia appliances are located. It can be the living room or another room dedicated to watching television, and more generally to consuming different forms of multimedia content.

Considering the current importance of the consumption of live or recorded television (and related activities like watching DVDs), the present method and system mainly targets televisions and the related appliances, for which a remote control 110 is used to perform user's interactions.

Thus, as exemplified in FIG. 1, the environment of the metering system 120 consists of a television 100, a STB 102, a DVD player 104 and a PVR 106. All of these multimedia appliances are operated remotely by a user via the remote control 110. As mentioned earlier, any other multimedia appliance that is controlled via the remote control 110 can be monitored by the metering system 120. The interactions between the remote control 110 and an associated multimedia appliance (for example the television 100) are based on a protocol to transmit the user's interactions generated via the remote control to the multimedia appliance.

Any transmission 150 from the remote control 110 to the multimedia appliances, for example the television 100 as represented in FIG. 1, is also received by the metering system 120. For this purpose, the metering system 120 is equipped with the same type of receiver technology 140, as the multimedia appliances, for example the television 100 as represented in FIG. 1. Nowadays, infrared is the usual transmission technology for remote controls and thus the receiver 140 is an infrared receiver. Alternatively, radio frequency may be used for remote controls, in which case the receiver 140 is a radio frequency receiver. In the case where several transmission technologies for remote controls coexist, the metering system is adapted for supporting all of them, by including several appropriate receivers 140.

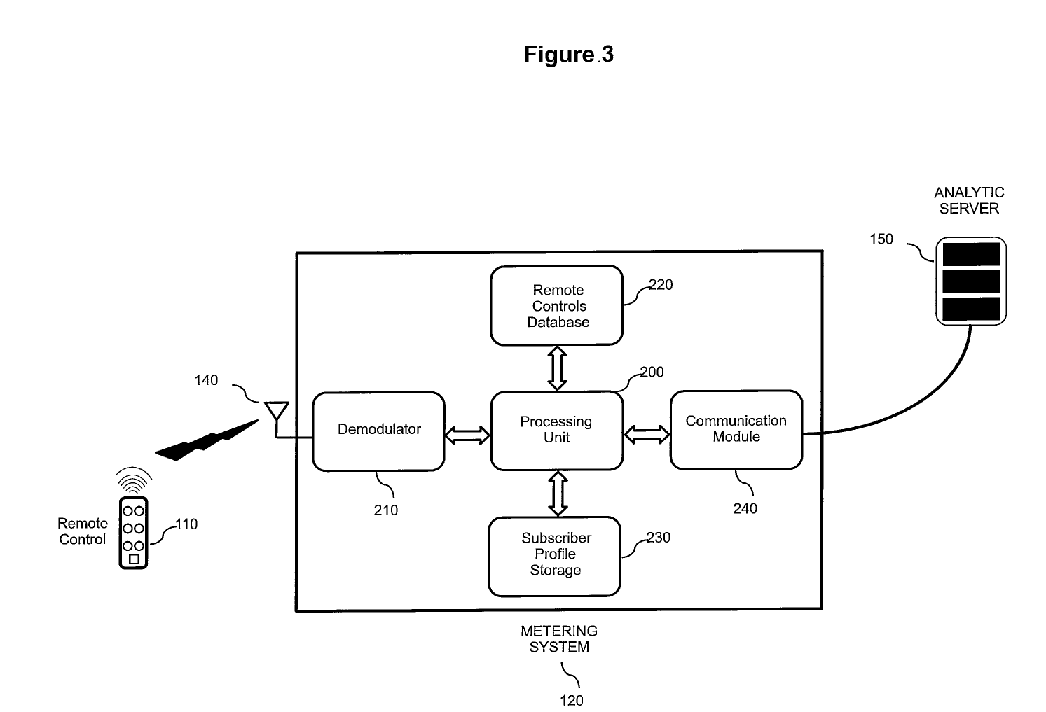

All the transmissions 150 intercepted by the metering system 120 are processed and interpreted, in order to generate a subscriber profile. Mode details on this operation will be given in FIG. 3, where a metering system architecture is detailed.

The subscriber's profile is transmitted to a centralized analytic server 150, operated by a service provider 30. The notion of service provider is generic and includes any entity interested in gathering marketing information about subscribers on a large scale. The most obvious example is the company that is providing television services to the subscriber. It can be a cable or satellite television operator, as well as an ISP (Internet Service Provider) providing IPTV based television services. Alternatively, it can be a third party company, specialized in marketing studies related to multimedia consumption trends. For example, since the metering device 120 is a standalone device, it can be operated by the third party company in collaboration with the television service provider, or alternatively independently from the television service provider.

The centralized analytic server 150 analyses the transmitted subscriber's profiles and generates reports either at the subscriber level or from a general marketing perspective. For instance, the subscriber's profile may comprise the list of multimedia appliances detected by the metering system 120. In the example of FIG. 1, the television 100, the STB 102, the DVD 104 and the PVR 106 are listed for the subscriber's premises 10. This information can be used to generate targeted offerings for the acquisition of a multimedia appliance, only to the subscribers who do not already own this type of appliance, according to the information gathered by the metering system 120. For example, the subscribers who do not own a PVR could receive an offer to acquire a standalone PVR, or to upgrade their STB to an integrated STB and PVR equipment. The offer can be made by the television service provider itself if it is the service provider 30, or by a consumer electronic vendor which acquired the marketing data from a third party service provider 30.

A third party service provider 30 can also use the list of multimedia appliances per monitored subscriber to generate statistics on the penetration rate of various multimedia appliances. This type of study can then be sold to consumer electronics manufacturers. The advantage of the present method and system is that the evolution of the penetration rate of various multimedia appliances is followed almost in real time, since the metering system 120 can generate an update on a daily basis to the centralized analytic server 150. The other advantage is that this type of study is fully automated and can potentially involve a large statistical base, depending on the number of metering systems 120 deployed.

The granularity of the information gathered by the metering system 120 and related to the list of multimedia appliances present at the subscriber's premises 10 depends on the communication protocol supported by the remote control 110. As mentioned above, the minimal functionality is to detect and distinguish the different types of multimedia appliances (television, STB, DVD, PVR . . . ). Additional information may be available for a specific type of appliance. For instance, in the case of a television, the remote control may need to be programmed to generate a specific signaling sequence to interact with specific models of television appliances (usually a group of models within the same brand). In this case, the metering system 120 is capable of detecting the model of the television 100 (at least the brand or the family of models within the same brand), by recognizing the associated specific signaling sequence. Additional information for a television, like the specific model within a brand or specific characteristics (e.g. the size of the screen, the compatibility with advanced interactive services), are currently not available via the interactions between the remote control 110 and the television 100. However, if this type of information becomes available in the future, it will be of great interest for the service provider 30. This may be the case if more interactivity is introduced in the communications between the remote control and the multimedia appliances. Currently, it is basically the remote control sending orders to the appliances and there is no feedback from the appliances to the remote control. The use of Radio Frequency instead of infrared in the future may allow more sophisticated communication protocols between the remote control and the multimedia appliances, allowing the metering system 120 to generate a richer subscriber's profile. Consequently, the centralized analytic server 150 may produce reports with more added value in terms of marketing opportunities.

Additionally, the metering system 120 records when and for how long a specific multimedia appliance is used. This information is obtained by processing the interactions related to a specific multimedia appliance, and interpreting some of these interactions as being representative of the beginning/end of usage of the multimedia appliance based on the intercepted transmissions. The timestamps associated to these representative interactions are used to date the beginning and end of usage. This type of information is also added to the subscriber's profile and exploited by the centralized analytic server 150. For instance, a subscriber who makes an intensive use of its DVD player may be a good candidate to subscribe to the VOD (Video On Demand) service of the television provider.

Also, for a given appliance, actions of special interest are recorded. For example, in the case of a PVR, the metering system 120 detects when the PVR is in recording mode, and when it is in viewing mode. This type of information is also added to the subscriber's profile and exploited by the centralized analytic server 150. For instance, a subscriber who constantly uses its PVR to record television and watches it at the same time, using the fast forward command at regular intervals, can be identified as a subscriber who uses its PVR to avoid watching commercials.

The transmission of the subscriber's profile from the metering system 120 to the centralized analytic server 150 is performed via a transmission media 20. One possibility is to use a fixed Internet connection from an ISP, available at the subscriber's premises 10. Another possibility is to use a mobile data network. The metering system 120 includes a module that supports the appropriate transmission technology, as will be described in FIG. 3.

A unique identifier of the metering system 120 is included in the subscriber's profiles transmitted to the analytic server 150. A mapping table correlating the unique identifiers of the metering systems and the associated subscriber's households is memorized by the analytic server 150. Using this mapping table, a received subscriber's profile can be immediately matched with the corresponding subscriber's household. Thus, the data contained in the received subscriber's profile can be processed, and the resulting information added to a matching long term subscriber's profile generated and stored by the analytic server 150. Various types of identifiers can be used: for example, a unique serial number allocated to each metering system, or the Media Access Control (MAC) address of its networking interface.

Generally speaking, the centralized analytic server 150 generates statistics on ownership and usage patterns of various types of multimedia appliances, by analyzing the ownership and usage information recorded in long term subscriber's profiles.

The long term subscriber's profiles, generated and stored by the analytic server 150, are representative of the history and evolution of the multimedia environment of each specific subscriber's household (the history may represent several years of data with the desired granularity: days, weeks, months). The analytic server performs business intelligence oriented analysis of the long term subscriber's profiles, to generate general or subscriber's specific reports, which can be exploited from a marketing perspective, as previously mentioned.

Some households are equipped with an above average set of multimedia appliances, resulting in several members of the household having their own dedicated multimedia appliance located in a particular room. In this case, a main metering system 120 is deployed in one room and secondary metering systems are deployed in the other rooms. The secondary metering systems have the same capabilities as the main metering system. The only difference is that the secondary metering systems report their data to the main metering system to generate an aggregated subscriber's profile. The main entity performs the transmission of this aggregated profile to the centralized analytic server 150. The main and secondary metering systems communicate via an internal communication network deployed in the household (for instance, an Ethernet network or a WIFI network).

Currently, audience metering systems targeting the television audience measurement are already deployed by a portion of the television service providers or third party audience measurement firms, in selected subscriber's households (usually, the selection of the subscriber's households panel from a larger population of television's subscribers is based on specific socio-demographic characteristics). The main objective of these audience metering systems is to monitor which television channels and which television programs are being viewed. The audience metering systems are either implemented as a standalone device, or as a dedicated software embedded in an equipment deployed at the user's premises, like the STB. The metering system 120 of the present method and system may be integrated with such audience metering systems, to leverage the functionalities that exist in both systems. An example of such common functionality is the transmission function to a centralized analytic server 150. Additionally, a close integration of the two systems may generate additional correlated data to enrich the subscriber's profiles, and to be further analyzed by a common centralized analytic server 150.

Referring now to FIG. 3, a metering system of a method and system for remote control interactions analytics will be described.

The components of the metering system 120 of FIG. 1 are detailed in FIG. 3. The receiver 140 has already been mentioned in FIG. 1. It intercepts all the transmissions generated by the remote control 110. Since the current transmission technology for remote controls is infrared, the receiver 140 is an infrared receiver. Additionally, since almost all remote controls operate on a 36 kHz (kilo hertz) carrier frequency, the infrared receiver 140 is tuned to this frequency. The receiver is also able to operate on different frequencies around the 36 kHz band, to support the most common models of remote controls that may operate on a slightly different frequency. As already mentioned, if the use of radio frequency technologies emerges in the future (to design more advanced remote controls), the receiver 140 shall also support the associated radio frequencies.

The central entity of the metering system 120 is the processing unit 200. It performs all the processing and coordinates the interactions with the other components: the demodulator 210, the remote controls database 220, the subscriber profile storage 230 and the communication module 240.

The demodulator 210 analyzes the transmissions received by the receiver 140 according to the specific communication protocol of the remote control 110. Thus, the first step is to recognize the communication protocol in use. The remote control database 220 contains a list of the most common models of remote controls, with the characteristics of the associated communication protocols. In the case of infrared technology, each communication sequence generated by the remote control includes: an optional start sequence, a command sequence and an address sequence. A set of 0 and 1 is used to encode the command and address sequences. The address sequence identifies a particular multimedia appliance (e.g. TV, STB, DVD) and the command sequence identifies a command addressed to this appliance (e.g. start, stop, channel selection). A specific infrared remote control communication protocol (supported by a specific model) is partially identified by the duration of the start, command and address sequences. Additionally, the encoding of the command and address sequences is also a differentiator between different remote control communication protocols.

In the most favorable case, the remote control 110 is a universal remote control, which can control all the multimedia appliances in its vicinity. Thus, the receiver 140 and the demodulator 210 operate on a single remote control communication protocol. In a less favorable case, several remote controls 110 are used to control various multimedia appliances, and the receiver 140 and demodulator 210 operate on the different remote control communication protocols supported by the various remote controls. Thus, the role of the remote controls database 220 is first to enable the receiver 140 to discover the proper frequency used by the remote control 110 for its transmissions, among a list of frequencies stored in the database. It then enables the demodulator 210 to identify the proper communication protocol used by the remote control 110 and to interpret the various communication sequences. For this purpose, the list of supported remote control communication protocols is stored, with the appropriate characteristics to recognize and interpret them.

The processing unit 200 further processes the communication sequences (sent by the remote control to a multimedia appliance) detected by the demodulator 210. The processing unit 200 interprets these communication sequences to generate information stored in the subscriber's profile storage 230. A timestamp is generated for each detected communication sequence of interest, and associated to the related information stored in the subscriber's profile. The remote controls database 220 contains all the data necessary to properly interpret specificities of a given remote control communication protocol.

The processing and interpretation of a communication sequence is similar for any type of technology (e.g. infrared, radio frequency) used by a remote control to interact with the related multimedia appliances. First, the identification of the targeted multimedia appliance is performed, and it is determined if this targeted multimedia appliance is already recorded in the subscriber's profile. If it is not, it is added to the subscriber's profile, with all the information available to characterize this multimedia appliance (type, manufacturer, model, characteristics, if available).

In this first step, the interpretation of the communication sequence consists in identifying the targeted multimedia appliance, and gathering the available characterization information. The remote control database 220 contains the necessary information to perform the identification and characterization: the identifier of the targeted multimedia appliance extracted from the communication sequence is used as an index for the database 220, to retrieve the corresponding information stored in the database 220: type of appliance (e.g. TV, or DVD, or PVR . . . ), manufacturer, model, characteristics.

In the case of infrared technology, the address sequence of the communication sequence is used for the identification of the targeted multimedia appliance.

Then, the identification of the interaction between the remote control and the targeted multimedia appliance is performed. For each type of multimedia appliance, a pre-defined list of interactions to monitor is stored in the remote controls database 220. It is determined if the interaction between the remote control and the targeted multimedia appliance belongs to the pre-defined list of interactions to monitor. In this case, an event is stored in the subscriber's profile, referencing the targeted multimedia appliance, the type of interaction, and a timestamp of detection. Following are examples of pre-defined lists of interactions to monitor. For a television: TV on, TV off, select channel. For a PVR: start recording, stop recording, start playing, stop playing, fast forward. Additionally, a distinction is made between simple and complex interactions. A simple interaction consists of a command without additional parameters, for example TV on. A complex interaction consists of a command with one or several additional parameters, for example select TV channel. In the case of a complex interaction, the interpretation of the command consists in two steps: first identifying the command (e.g. select TV channel), and then the associated parameter(s) (e.g. the selected TV channel).

Furthermore, an interaction can be interpreted as being indicative of the beginning or the end of usage of a specific multimedia equipment. This allows for the recording of the time periods of usage of each multimedia equipment (a timestamp for the beginning and a timestamp for the end). In the case of a TV, the commands “TV on” and “TV off” can be used to assess the periods of usage. In the case of a DVD, the commands “DVD on” or “DVD play”, and “DVD off” or “DVD stop” can be used to assess the periods of usage. In the case of a PVR, the commands “PVR start recording” and “PVR stop recording”, as well as “PVR start playing” and “PVR stop recording”, can be used to assess the periods of usage.

In the case of infrared technology, the command sequence of the communication sequence is used for the identification of the interactions between the remote control and the targeted multimedia appliance.

Additionally, the processing unit 200 synchronizes the interactions between the remote controls database 220 and the demodulator 210/receiver 140. It also synchronizes the interactions between the subscriber profile storage 230 and the communication module 240.

The subscriber profile storage 230 stores a subscriber's profile, based on the information extrapolated from the interpretation of the interactions of the remote control 110 with the associated multimedia appliances. The information which can be stored in the subscriber's profile has already been detailed. It includes the list of all the multimedia appliances that have been detected (their type, and their specific manufacturer, model, and characteristics, if available). It also includes, for each specific multimedia appliance, timestamps of the beginning and end of each usage period. Additionally it includes, for each specific multimedia appliance, a list of events of interest with a timestamp for each specific interaction (e.g. “TV on” with timestamp, “TV off” with timestamp, “select TV channel N” with timestamp, “DVD player on” with timestamp, “fast forward on PVR” with timestamp . . . ).

The communication module 240 transmits the updated subscriber's profile to the centralized analytic server 150, on a regular basis, under the control of the processing unit 200. As already mentioned, the transmission can be performed over a fixed broadband internet connection, or alternatively via a mobile data connection. The communication module 240 can also be used to automatically update the remote controls database 220, allowing an easy upgrade (from a centralized reference server not displayed on FIG. 3) with new models of remote controls to be supported by the metering systems 120 deployed in each household.

Based on the capabilities of the processing unit 200 and the subscriber profile storage 230, the analysis of the subscriber's profile may be performed by the centralized analytic server 150 only, or shared between the metering system 120 and the centralized analytic server 150. Specifically, pre-processing of the raw subscriber's profile data by the metering system 120 may save processing time and storage capacities of the centralized analytic server 150.

Although the present method and system have been described in the foregoing specification by means of several non-restrictive illustrative embodiments, these illustrative embodiments can be modified at will within the scope, spirit and nature of the appended claims.

What is claimed is:

1. A method for analyzing interactions between a remote control and associated multimedia appliances, the method comprising:
intercepting transmissions representative of said interactions between the remote control and the associated multimedia appliances;
extracting data related to said interactions from said transmissions;
processing and interpreting said data related to said interactions, the processing comprising allocation of a timestamp to some of the interactions;
generating a subscriber's profile based on said interpretation of the data related to the interactions;
storing said subscriber's profile; and
transmitting said subscriber's profile to a centralized analytic server.

2. The method of claim 1, wherein the subscriber's profile comprises a list of all the multimedia appliances which have been detected.

3. The method of claim 2, wherein for each multimedia appliance in the list, at least its type, and additionally its manufacturer, model, and specific characteristics, are recorded in the subscriber's profile.

4. The method of claim 3, wherein the type of multimedia appliance includes at least one among a television, a set top box, a digital video disk, a personal video recorder, a home theatre equipment, and a stereo equipment.

5. The method of claim 4, wherein for each multimedia appliance in the list, timestamps of the beginning and end of each usage period of the appliance are recorded in the subscriber's profile.

6. The method of claim 4, wherein for each multimedia appliance in the list, a set of pre-determined interactions between the remote control and the multimedia appliance are recorded in the subscriber's profile, along with a timestamp of when the interaction has been intercepted.

7. The method of claim 1, wherein the centralized analytic server generates and stores long term subscriber's profiles based on the information extracted from the transmitted subscriber's profiles.

8. The method of claim 7, wherein the centralized analytic server further performs marketing analysis on the long term subscriber's profiles to identify specific subscribers as potential targets for the acquisition of a selected type of multimedia appliance or the acquisition of a multimedia service related to a selected type of multimedia appliance.

9. The method of claim 7, wherein the centralized analytic server performs marketing analysis on the long term subscriber's profiles, to generate statistics on ownership and usage patterns of various types of multimedia appliances.

10. A system for analyzing interactions between a remote control and associated multimedia appliances, the system comprising:
a receiver for intercepting transmissions representative of said interactions between the remote control and the associated multimedia appliances;
a demodulator for extracting data related to said interactions from said transmissions;
a processing unit for processing and interpreting said data related to said interactions, and for allocating a timestamp to some of the interactions, the processing unit further generating a subscriber's profile based on said interpretation of the data related to the interactions;
a storage entity for storing said subscriber's profile; and
a communication module for transmitting said subscriber's profile to a centralized analytic server.

11. The system of claim 10, wherein the transmissions representative of the interactions between a remote control and the associated multimedia appliances are based on at least one of the following technologies: infrared signal transmissions, and radio frequency signal transmissions.

12. The system of claim 11, wherein the subscriber's profile includes a list of all the multimedia appliances which have been detected.

13. The system of claim 12, wherein for each multimedia appliance in the list, at least its type, and additionally its manufacturer, model, and specific characteristics, are recorded in the subscriber's profile.

14. The system of claim 13, wherein the type of multimedia appliance includes at least one among a television, a set top box, a digital video disk, a personal video recorder, a home theatre equipment, a stereo equipment.

15. The system of claim 14, wherein for each multimedia appliance in the list, timestamps of the beginning and end of each usage period of the appliance are recorded in the subscriber's profile.

16. The system of claim 14, wherein for each multimedia appliance in the list, a set of pre-determined interactions between the remote control and the multimedia appliance are recorded in the subscriber's profile, along with a timestamp of when the interaction has been intercepted.

17. The system of claim 10, wherein the centralized analytic server generates and stores long term subscriber's profiles based on the information extracted from the transmitted subscriber's profiles.

18. The system of claim 17, wherein the centralized analytic server performs marketing analysis on the long term subscriber's profiles to identify specific subscribers as potential targets for acquiring a selected type of multimedia appliance or a multimedia service related to a selected type of multimedia appliance.

19. The system of claim 17, wherein the centralized analytic server performs marketing analysis on the long term subscriber's profiles, to generate statistics on ownership and usage patterns of various types of multimedia appliances.
